(19) United States
(12) Patent Application Publication
(10) Pub. No.: US 2026/0220126 A1
(43) Pub. Date: Jul. 30, 2026

(54) SYSTEMS AND METHODS USING TRAINED MODELS TO GENERATE SYNTHETIC SEARCH QUERIES TAGGED TO ITEM ATTRIBUTES

(71) Applicant: Walmart Apollo, LLC, Bentonville, AR (US)

(72) Inventors: Siddharth P. Singh, Fremont, CA (US); Jayant Sachdev, Sunnyvale, CA (US); Aditya Singh, Fremont, CA (US); Chittaranjan Tripathy, Sunnyvale, CA (US)

(21) Appl. No.: 19/041,161

(22) Filed: Jan. 30, 2025

(51) Int. Cl. G06F 16/242; G06N 3/092

(52) U.S. Cl. CPC G06F 16/242; G06N 3/092

(57) ABSTRACT

There are provided systems and methods that use trained models and large language models (LLMs) to generate synthetic search queries with tagged item attributes. The system includes: a database containing items with attributes and values associated with the attributes; a processing resource; and a machine readable medium storing instructions that cause the processing resource to: generate, using a first trained model, a first prompt to query an LLM to extract focused item attributes for an item; receive the focused product attributes; generate, using a second trained model, a second prompt based on the focused item attributes to query the LLM to generate synthetic search queries; tag, using the second trained model, each of the synthetic search queries with value pairs that include a focused item attribute and a value for that attribute; and receive the tagged synthetic search queries.

### TECHNICAL FIELD

This disclosure relates generally to trained machine learning models, and more particularly, to trained machine learning models and item search queries.

### BACKGROUND

In ecommerce and other settings, users expect relevant items when they enter a search query at a search interface of an ecommerce platform. User search queries vary by the intent of the users. High intent user queries are user queries that target specific item attributes, like, for example, gender, color, size, quantity, brand, etc. It is desirable to improve relevance of the responses to these high intent user search queries by tagging the user search queries with associated item attributes.

### BRIEF DESCRIPTION OF THE DRAWINGS

Disclosed herein are embodiments of systems, apparatuses and methods involving synthetic search queries and tagged associated item attributes. This description includes drawings, wherein:

FIG. 1 is a block diagram depicting an example system for generating and tagging synthetic search queries using trained models in accordance with some embodiments;

FIG. 2 is a block diagram depicting an example system for generating synthetic search queries using trained models and large language models in accordance with some embodiments;

FIG. 3 is a block diagram depicting an example system that includes a prompt involving an item with item attributes and the generated synthetic search queries in accordance with some embodiments;

FIG. 4 is a flow diagram depicting an example method for generating synthetic search queries in accordance with some embodiments; and

FIG. 5 is a block diagram depicting a machine readable medium with example instructions for generating synthetic search queries in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present disclosure. Also, common but well-understood elements that are useful or necessary in a commercially feasible embodiment are often not depicted in order to facilitate a less obstructed view of these various embodiments of the present disclosure. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

The following description is not to be taken in a limiting sense, but is made merely for the purpose of describing the general principles of example embodiments. Reference throughout this specification to “one embodiment,” “an embodiment,” “some embodiments”, “one form,” “some forms,” “an implementation”, “some implementations”, “some applications”, or similar language means that a particular feature, structure, or characteristic described in connection with the embodiment is included in but is not limited to at least one embodiment of the disclosure. Thus, appearances of the phrases “in one embodiment,” “in an embodiment,” “in some embodiments”, “in some implementations”, and similar language throughout this specification may, but do not necessarily, all refer to the same embodiment.

In one aspect, and without limitation, the disclosure addresses using trained models and large language models (LLMs) to generate synthetic search queries to improve relevancy of items, e.g., products, returned in response to a user search query. User search queries are generally entered through an interface of an ecommerce site, and search results relevant to the search query can include a list of items that may be of interest to the user. In determining the search results, a search interface may tag a user search query with item attributes, e.g., product attributes, and items with matching attributes may be output.

In one aspect, and without limitation, this disclosure addresses issues relating to searching where a user inputs a high intent user search query, e.g. a search query with a sequence of specific item attribute values. The high intent user search query may include a sequence or string of specific item attribute values that are combined into one user search query. A high intent user search query is a fairly detailed search query that indicates that the user has a fairly specific item or type of item in mind. With current searching, however, it has been found that not all item attributes get same distribution of engagement; item attributes evolve over time, which leads to cold start problems for new items and underengaged items; and historical user search queries may not be representative of all kinds of possible relevant search queries that can be used to improve item searching and discovery.

In one aspect, and without limitation, this disclosure addresses generating synthetic high intent user search queries (using trained models and LLMs) from a catalog to enrich training data. A catalog may have item attributes, such as titles, color, size, and gender, and corresponding item attribute values, such as phone, red, rectangular, and female. The above information may be used to collect item attributes and values for an item. This disclosure may use LLMs as a tool to generate synthetic high intent user search queries that contain relevant intent focusing on these additional item attributes and values. In some forms, LLMs can analyze large amounts of text data and can comprehend the content, context, and subtleties of the language of the text. After analyzing the text data, LLMs can generate natural language content in response, which is well suited to generating synthetic search queries simulating human language queries. Further, these high intent synthetic user queries may be used with tagged attributes and values to fine tune sequence tagger models associated with search interfaces. These synthetic attribute-tagged queries can be utilized for improving search relevance for underrepresented, cold-start items and emerging attributes in e-commerce. In addition, feedback may be used to improve the trained models over time.

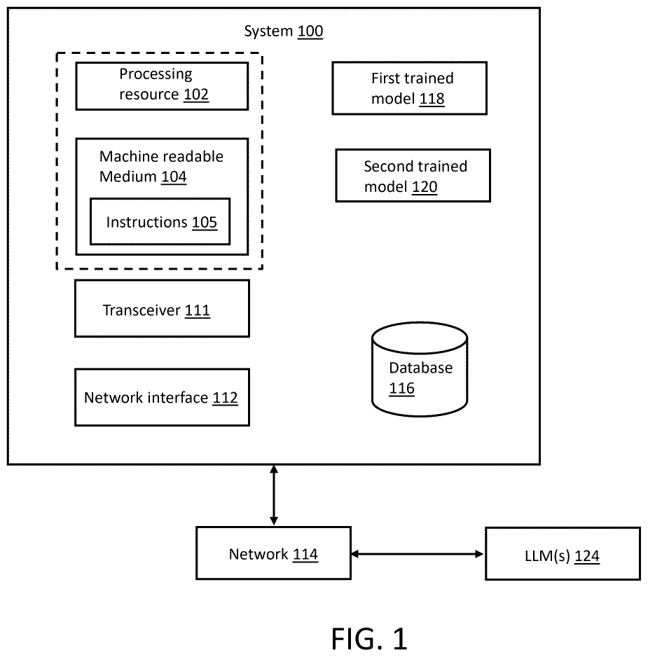

Referring now to the figures, FIG. 1 depicts an example system 100 that uses trained models and LLMs to generate synthetic search queries. As used herein, trained models generally refer to machine learning models that have been taught to perform specific tasks by training them with data sets. Large language models (LLM) are specific types of machine learning models known in the art that use data to generate outputs relating to language.

The system 100 includes a processing resource 102 that may include a microcontroller, a microprocessor, central processing unit core(s), an application-specific integrated circuit (ASIC), a field programmable gate array (FPGA), etc. The system 100 includes machine readable medium 104 that may be non-transitory and include random access memory (RAM), read-only memory (ROM), electrically erasable programmable read-only memory (EEPROM), flash memory, a hard disk drive, etc. The processing resource 102 may execute instructions 105 (i.e., programming or software code) stored on machine readable medium 104 to perform functions of the system 100. Additionally, or alternatively, the processing resource 102 may include electronic circuitry for performing the instructions and functionality described herein.

The system 100 includes a processing resource 102 that may include a microcontroller, a microprocessor, central processing unit core(s), an application-specific integrated circuit (ASIC), a field programmable gate array (FPGA), etc. The system 100 includes machine readable medium 104 that may be non-transitory and include random access memory (RAM), read-only memory (ROM), electrically erasable programmable read-only memory (EEPROM), flash memory, a hard disk drive, etc. The processing resource 102 may execute instructions 105 (i.e., programming or software code) stored on machine readable medium 104 to perform functions of the system 100. Additionally, or alternatively, the processing resource 102 may include electronic circuitry for performing the instructions and functionality described herein.

In that regard, the processing resource 102 may be configured to execute and perform certain operations. In this context, the term processing resource 102 refers broadly to any microcontroller, computer, or processor-based device with processor, memory, and programmable input/output peripherals. As shown in FIG. 1, the processing resource 102 may be coupled to a communication transceiver 111 and a network interface 112, which, in turn, may be coupled to wireless network(s) 114. The network interface 112 may enable the processing resource 102 to communicate with other elements (both internal and external to the system 100). The network interface 112 can communicatively couple the processing resource 102 to the wireless network 114 and whatever other networks 114 may be appropriate for the circumstances.

The processing resource 102 may make use of cloud databases and/or operate in conjunction with a cloud computing platform. The processing resource 102 may be coupled to and/or communicate with one or more databases (such as database 116). Also, in some forms, as shown in FIG. 1, the one or more databases constitute local storage accessible to the system 100, while in other forms, they may constitute remote storage accessible via the network(s) 114. While one processing resource 102 is shown, in some forms, the functionalities of the processing resource 102 may be implemented on a plurality of processor devices communicating on a network 114.

In addition, the system 100 may include several trained models. More specifically, it may include a first trained model 118 and a second trained model 120. The operation and interaction of these trained models 118 and 120 is described further below. In the example shown in FIG. 1, the trained models 118 and 120 are part of the system 100. For example, they may be stored and executed on servers of the system 100. In other forms, one or more of the trained models 118 and 120 may be separate from the system 100 and may be accessible by the network 114, such as where the trained models 118 and 120 may be maintained on a cloud computing platform or database. In some forms, the processing resource 102 and the machine readable medium 104 may be part of a cloud computing system and at least one of the first trained model 118 and the second trained model 120 may be executed by the cloud computing system.

The system 100 also communicates with one or more LLMs 124 via network 114. In some forms, it is contemplated that a single LLM may be used to perform the operations described in this disclosure. In other forms, it is contemplated that multiple LLMs may be used that may be implemented one after another in a series operation or that may be implemented at the same time in a parallel operation. In some embodiments, the one or more LLMs 124 may be trained by third parties and residing and executed in a third party cloud server environment. In some embodiments, example LLMs include: GPT-4 and ChatGPT from OpenAI; BERT, T5, Bard from Google; Claude 3.5; Llama from Meta; and Bing Chat from Microsoft. In some embodiments, the one or more LLMs 124 may be downloaded from third parties and trained using data specific to the system 100, and executed on server/s controlled by the system 100 developer.

In some embodiments, one or both of the first trained model 118 and the second trained model 120 may be implemented as LLM agents. LLM agents are model interfaces that may be systems built on top of a machine learning model (e.g., an LLM) that may interact with external tools and application programming interfaces (APIs). A machine learning agent may further maintain a state and/or context across multiple steps by calling a machine learning model multiple times and recalling the input(s) and/or output(s) of each call. In some aspects, a machine learning agent may autonomously work toward specific goals (e.g., by planning a series of steps and delegating the steps to additional machine learning models). In other words, a machine learning agent utilizes machine learning models along with additional tools (e.g., open-source resources, search engines, additional models, etc.) in order to complete tasks.

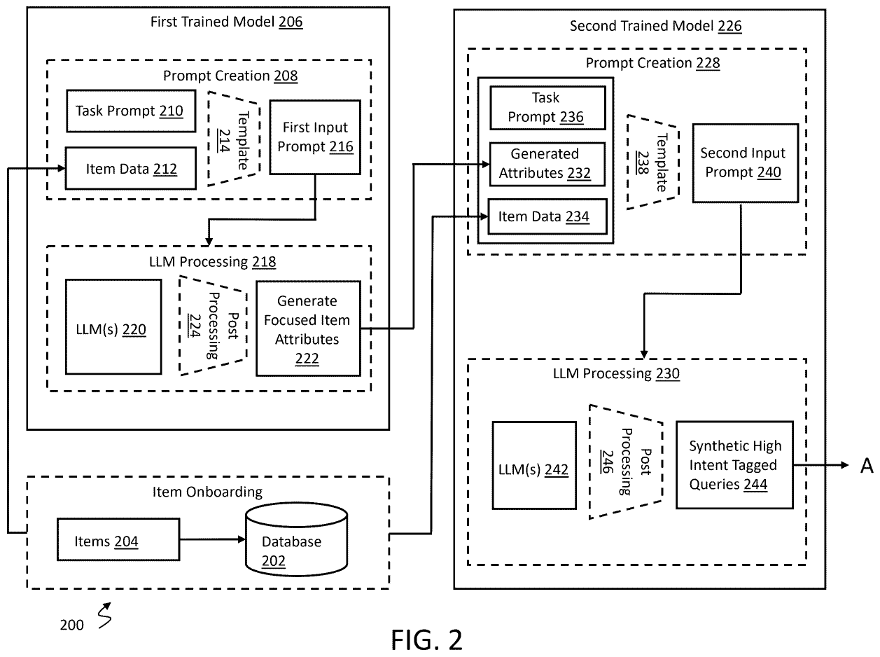

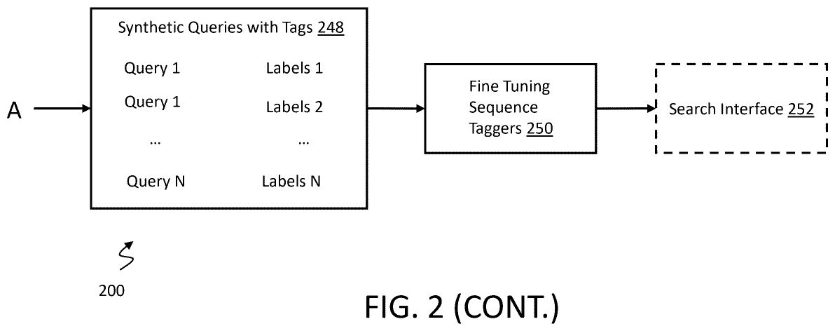

FIG. 2 depicts a block diagram showing a general example of a system 200 that uses trained models and LLM(s) to generate synthetic search queries. FIG. 2 depicts an example of how the processing resource 102 executing instructions 105 of FIG. 1 uses models 118 and 120 to perform the functionality described above as further detailed below with respect to FIG. 2. In some forms, it is generally contemplated that trained models 206 and 226 may be analogous to trained models 118 and 120, LLMs 220 and 242 may be analogous to LLM(s) 124, and database 202 may be analogous to database 116.

In one form, as shown in FIG. 2, there is a database 202 that may include an item catalog containing items 204 with attributes and values associated with the attributes. An item catalog generally refers to any listing of items and may include any of various kinds of information about the items. For example, it may contain an item title, item description, and/or a listing of features and attributes of the item. In this context, the term attribute refers to a general characteristic with several possible forms, such as, for example, “color”, and the term value refers to a specific form, such as, for example, “red”. So, for example, item attributes may include one or more of brand, color, item line, condition, size, and model.

The processing resource 102 may use a first trained model 206 to generate a first input prompt 216 to query at least one large language model (LLM) 220 to extract focused item attributes for a specific item. The first input prompt 216 to the LLM(s) 220 provides the LLM(s) 220 information about the item, which may be the input text provided to guide the LLM(s) 220 towards generating the focused item attributes 222. The first trained model 206 may function as an attribute extraction component that utilizes item information or data 212 to generate attributes focused to the specific item (e.g., attributes for a phone may include storage size but not clothing size). A first prompt generation component 208 utilizes a first task prompt 210 and item data 212. A template 214 provides a consistent and structured approach to generate the first input prompt 216 in view of the item data 212.

In one form, it is contemplated that this first trained model 206 may be directed to emerging item attribute extraction, e.g. extracting attributes of new or otherwise underrepresented items. The processing resource 102 via the first trained model 206 may evaluate items, item attributes, and other item information in the item database 202 (includes catalog of items), which may also include input provided by sellers of the items. In some forms, the item catalog may include input from individuals selling the item regarding attributes of the items. Thus, item information regarding a specific item may include, for example, input from individuals selling the specific item, a description of the specific item, and/or a title of the specific item.

The processing resource 102 via the first trained model 206 may receive a large number of general attributes and other general information regarding items as the first input prompt 216. These general attributes and other general information regarding items are submitted for LLM processing 218 to the at least one LLM 220 to generate focused item attributes 222. For example, the at least one LLM 220 may consider attributes used frequently in a description of the specific item. As another example, the at least one LLM 220 may consider input from sellers, who may indicate that certain attributes cover their item and that certain other attributes do not. For example, a seller may identify ten specific attributes for phones. In this example, the focused item attributes are the ones that are relevant to phones (and not other items). The generated focused item attributes are those relevant to a particular item. In some forms, the generated focused item attribute 222 may include both an attribute and a value for the attribute, such as, for example, color: red.

The at least one LLM 220 converts numerous possible general attributes to focused attributes relevant to a specific item. In one form, the at least one LLM 220 may include one LLM. However, in other forms, the at least one LLM 220 may include multiple LLMs that are implemented one after another in a series operation or that are implemented at the same time in a parallel operation. Post-processing 224, such as by feedback, may be used to adjust the output of the LLM(s) 220 to confirm accuracy and/or consistency of the results. The processing resource 102 receives the focused item attributes for the specific item from the at least one LLM 220.

After the focused item attributes are generated, the processing resource 102 may use a second trained model 226, also in conjunction with LLM(s). In one form, the LLM(s) may be the same one or more LLMs that were used with the first trained model 206. In other forms, the LLM(s) may include one or more different LLMs than were used with the first trained model 206.

The processing resource 102 may use a second trained model 226 to generate a second input prompt 240 based on the generated focused item attributes 232 and based on item information or data 234 regarding the specific item to query the at least one LLM 242 to generate synthetic search queries 244 with each synthetic search query including a combination of values for the specific item. The second trained model 226 may function as a query generation model that includes a second prompt creation component 228 and an LLM processing component 230. The second prompt generation component utilizes the generated focused item attributes 232, item information 234 (e.g., attributes of an item shared by a seller, item description, item title, and so forth) associated with the specific item, and a second task prompt 236. Template 238 provides a consistent and structured approach to generate the second input prompt 240.

The second input prompt 240 is submitted for LLM processing 230 to at least one LLM 242 to generate synthetic high intent tagged search queries 244. The LLM(s) 242 use the generated focus items attributes 232 and the item data 234 to generate synthetic search queries 244 that are relevant to the specific item. As stated, in one form, the at least one LLM 242 may include one LLM, but in other forms, it may include multiple LLMs that are implemented one after another in a series operation or that are implemented at the same time in a parallel operation. Post-processing 246, such as by feedback, may be used to adjust the output of the LLM(s) 242 to confirm accuracy and/or consistency of the results. The processing resource 102 receives the synthetic high intent tagged queries 244 from the at least one LLM 242.

In some forms, it is contemplated that the first and second trained models 206 and 226 may be components of a single, comprehensive trained model. This single trained model may initially generate the first input prompt 216 that the LLM(s) may receive to generate the focused item attributes 222, and it may then use the generated focused item attributes 222 to generate the second input prompt 240 for second LLM processing 230 to generate the synthetic search queries 244. In this form, the single trained model may be viewed as performing an intermediate step of generating the focused item attributes 222 before a final step of generating the synthetic search queries 244.

Block 248 shows the results of the second trained model 226 generating synthetic search queries with tagged attributes. The processing resource 102 tags (or labels), using the second trained model 226, each of the synthetic search queries 244 with value pairs (tags or labels), and each value pair (tag or label) includes a focused item attribute and a value for the focused item attribute for the specific item. The second trained model 226 may function as a labeling/tagging model that labels the synthetic queries with focused item attributes and values, e.g., value pairs of attribute type and attribute, such as, for example, color: red.

The second trained model 226 may be used to generate a ground truth in machine learning that seeks to represent a target for training or validating a model. This ground truth may represent the goal or benchmark that is sought to be achieved. For example, at block 250, it is contemplated that the results of the second trained model 226 may be used to fine tune another trained model, e.g., to fine tune one or more sequence taggers or sequence tagging model(s). The sequence tagging model(s) may be associated with the search interface 252 and with user search queries received at the search interface 252. In one form, it may assign tags to user search queries at the search interface 252.

In one form, the labeled synthetic queries at block 248 may be sent to the sequence tagging model(s) at block 250. The sequence tagging model(s) at block 250 may be in communication with the search interface 252 of an ecommerce site and may use the labeled synthetic queries as a reference when tagging a user search query with item attributes. The use of labeled synthetic queries increases the relevancy of search results generated from a user search query. Alternatively, in some forms, the synthetic search queries and corresponding tagged value pairs may be used to modify the sequence tagging model(s) associated with the search interface. In some forms, the sequence tagging model(s) may assign tags to user search queries at the search interface.

Also, in some forms, it is contemplated that the trained models 206 and 226 themselves may be fine tuned continuously or periodically. For example, it is contemplated that the system 200 may use reinforcement learning models, such as, for example, reinforcement learning from human feedback (RLHF), to adjust and/or improve one or more of the trained models 206 and 226. Further, the fine tuning may include query overrides and/or manual evaluation. For example, in some forms, the processing resource 102 may instruct an RLHF model and receive feedback to modify the first trained model 206 and/or the second trained model 226.

In one form, the system 200 may use trained models and LLM(s) to generate synthetic high intent search queries relevant for focused item attributes. It may use synthetic search queries to fine tune sequence tagger models for improving site relevance. Further, it may use LLM(s) to proactively generate synthetic search queries for new/emerging attribute tags for furnishing relevant queries that users can use for additional discovery. Further, it provides a means for better understanding of user preferences and habits, which can be used to make search and personalization more relevant. It may provide greater precision in returning relevant items with underrepresented item attributes.

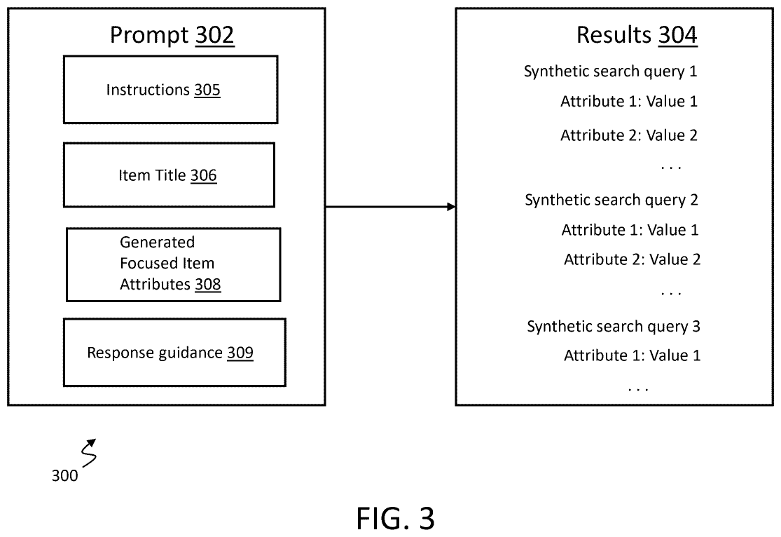

FIG. 3 depicts an example system 300 that includes a prompt 302 involving an item and the generated results 304 in the form of generated synthetic search queries and value pairs (of attribute and a value for that attribute). It is generally contemplated that this prompt 302 corresponds to the second input prompt 240 in FIG. 2. The prompt 302 may include natural language text, structured text, item titles, item descriptions, any other text format, and/or combinations thereof. For example, the prompt 302 may include the following initial instructions 305:“You are an eCommerce relevance expert. You work for a search-based platform of an eCommerce company. An eCommerce catalog item setup includes defining item attributes for items so that finding items that are similar becomes easier using these attributes. Some examples of these attributes are color, size, brand, gender, etc. Users come and search for relevant items using search queries on that platform. They expect to find items according to these attributes, such queries are referred to as high intent queries. Your task is to look at items and their attributes in the catalog and recommend relevant search queries that users may type to search for these items AND tag item attributes present in these queries. The item attribute tagging would look like this: ‘refurbished Apple iphone 12 Pro Max A2342 (Fully Unlocked) 128 GB Gold’ and it gets tagged as Brand: Apple; iPhone: Product line; Model: A2342; Color: Gold; and Size: 128 GB. Generate at least 10 relevant search queries that users may type to look for these items and its attributes and then tag these queries with the attributes. Make sure the queries need not match just on exact words but can also be semantically (meaningfully) relevant.”

Next, following these instructions 305, the prompt 302 may include a list of various items for which synthetic search queries are to be generated. In some forms, for each item, the prompt 302 may include an item title 306 and a list of attributes 308. In one form, it is contemplated that the attributes 308 correspond to the generated focused item attributes 222/232. As an example, the item title 306 may be “Refurbished Apple iphone 12 Pro Max A2342 (Fully Unlocked) 128 GB Gold (Grade A+).” Further, in this example, the attributes 308 might include the following: “Brand Name Apple; Clearout Deal No; Color Gold; Connectivity Lightning Port; Country of Origin Assembly US-United States; Fabric Property 6.7-inch Super Retina XDR display; Format 7; Hard Drive Capacity 128 GB; Model A2342; RAM Memory: 6GB; and Screen Size: 6.7in.”

In some embodiments, the prompts 302 may include guidance 309 as for the intended output, e.g., specifying one or more of the form or format of the response, words/phrases to avoid, and requesting that the LLM not hallucinate (i.e., base its answers on the information given and not make up answers or information). For example, in some embodiments, an example prompt may include the following: “Note: Do not hallucinate, only use the given product information to generate queries. Only generate search queries and don't add other explanation of text from your end like hello, sure, absolutely. Your output should be in the following format, replace <search_query> with your search queries and replace <attribute_1> and <attribute_2> with your attributes: #<search_query_1> <attribute_1> <attribute_2>, #<search_query_2> <attribute_1> <attribute_2>”.

Prompts 302 may be generated in various ways. The above example may be considered a form of abstractive prompt, which allows for generating synthetic queries that are not included verbatim in the item title 306 or item attributes 308. In other forms, it may be desirable to use an extractive prompt, which extracts language from the item title 306 or item attributes 308. In some forms, it is contemplated that templates (such as template 238) may be completed with specific information to generate the prompts 240/302.

After the prompt 302 is inputted, the system 300 generates the results 304. More specifically, after querying the LLM(s), the system 300 generates a listing of synthetic search queries and tagged value pairs. These synthetic search queries are relevant search queries that users might submit to search for this item. In this example, Synthetic Query 1 is “Apple iphone 12Pro Max Refurbished Gold.” The tagged value pairs (attribute: value) are: “Brand: Apple, Color: Gold, Product Line: iphone 12 Pro Max, and Condition: Refurbished.” In this example, Synthetic Query 2 is “128 GB iphone 12 Pro Max A2342 Gold color.” The tagged value pairs are: “Size: 128 GB, Product Line: iPhone 12 Pro Max, Model: A2342, and Color: Gold.” Synthetic Query 3 is “Apple iPhone with 6.7-inch Super Retina XDR display.” The tagged value pairs are: “Brand: Apple, Product Line: iPhone, and Screen Size 6.7 inches.” These results, in turn, may be used to fine tune sequence tagging models(s) associated with the search interface.

It should be understood that this example might include additional synthetic search queries and/or additional corresponding value pairs. Further, the synthetic search queries in this example may be considered high intent search queries in that they simulate a user inputting a string of values that include a number of user preferences. It should be understood that this phone example is provided for illustrative purposes and that many other types of items and item categories may be the subject of this approach.

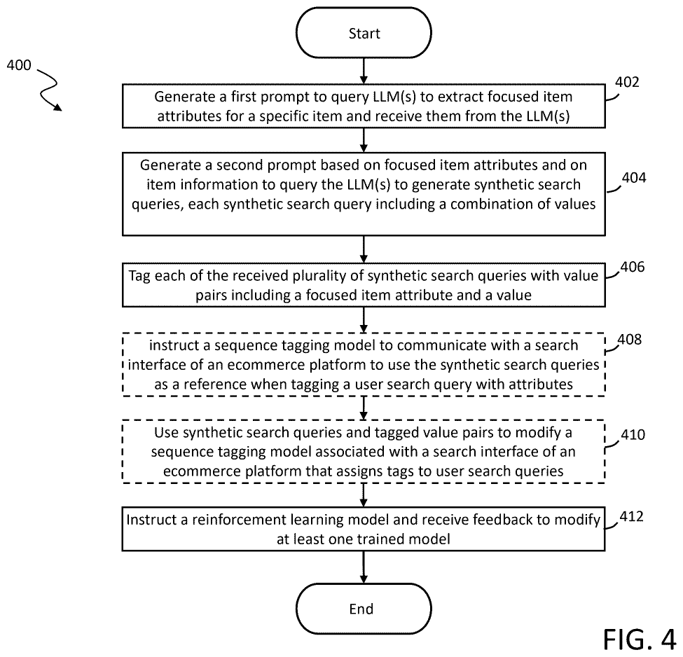

FIG. 4 depicts a flow diagram showing an exemplary method. In some forms, one or more blocks of the method may be performed at about the same time or in a different order than illustrated in the figures. In some forms, the method may not include all of the blocks/steps shown, may include additional blocks/steps, and/or some blocks/steps may be combined. In some forms, some of the blocks/steps may be repeated. It is generally contemplated that the method may be implemented in conjunction with executable instructions stored on a machine readable medium and a processing resource. Additionally, some aspects of the method may incorporate some of the components shown in FIGS. 1-3, such as the processing resource 102.

FIG. 4 depicts a flow diagram of a process 400 that may be used to generate synthetic search queries and tagged item attributes. At block 402, a first prompt is generated to query LLM(s) to extract focused item attributes for a specific item. The focused item attributes are then received from the LLM(s). In one form, it is contemplated that a processing resource using a first trained model may generate the first prompt and may receive focused item attributes.

At block 404, a second prompt is generated based on focused item attributes and based on item information to query the LLM(s) to generate synthetic search queries. Each synthetic search query includes a combination of values. In one form, it is contemplated that a processing resource using a second trained model to query the LLM(s) may be used in generating the second prompt and receiving the synthetic search queries. In some forms, the first and second trained models may be part of a single, comprehensive trained model.

At block 406, each of the plurality of synthetic search queries may be tagged (or labeled) with value pairs. Each value pair includes a focused item attribute and a value for the focused item attribute for the specific item, such as, for example, color and red. In one form, it is contemplated that a processing resource may be used to generate this tagging of each synthetic search query to multiple value pairs. In one form, it is contemplated that this output may represent a ground truth in machine learning, which may represent a goal or benchmark of what is to be achieved with searching.

Blocks 408 and 410 show two options involving a sequence tagging model. At block 408, a sequence tagging model is instructed to communicate with a search interface of an ecommerce platform to use the synthetic search queries as a reference when tagging a user search query with attributes. In one form, it is contemplated that the search interface is part of an ecommerce platform receiving user queries directed to items of interest to the user. In one form, it is contemplated that the synthetic search queries and tagged value pairs may include new or underrepresented item attributes and values.

Block 410 may be an alternative to block 408. At block 410, synthetic search queries and tagged value pairs may be used to modify a sequence tagging model associated with a search interface of an ecommerce platform. In this form, the sequence tagging model assigns tags to user search queries. In this form, the synthetic search queries and tagged value pairs may be used to modify the sequence tagging model so that one or more different items are returned to the user in response to a user search query.

At block 412, a reinforcement learning model is instructed and feedback is received to modify the first trained model and/or the second trained model. It is contemplated that the trained model(s) may need to be adjusted. Feedback, such as, for example, query overrides and manual evaluation, may be used to improve the trained model(s).

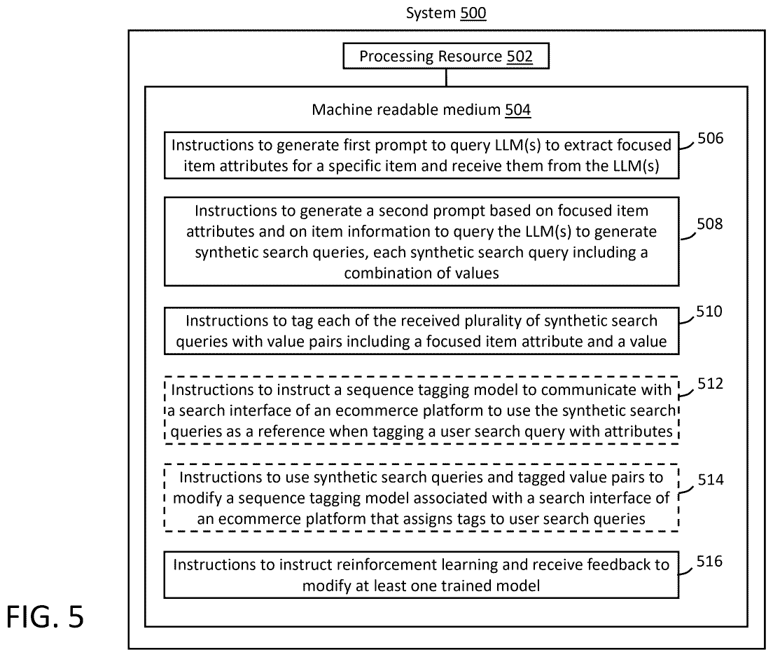

FIG. 5 depicts an example system 500 that includes non-transitory, machine readable media 504 that are encoded with example instructions executable by a processing resource 502. In some forms, the system 500 may be useful for implementing aspects of the systems 100 and 200 of FIGS. 1-2 or for performing aspects of process 400 of FIG. 4. For example, the instructions encoded on machine readable media 504 may be included in instructions 105 of FIG. 1. The processing resource 502 may include a microcontroller, a microprocessor, central processing unit core(s), an ASIC, an FPGA, and/or other hardware device suitable for retrieval and/or execution of instructions from the machine readable media 504 to perform functions related to various examples. Additionally, or alternatively, the processing resource 502 may include or be coupled to electronic circuitry or dedicated logic for performing some or all of the functionality of the instructions described herein.

The machine readable media 504 may be of any medium suitable for storing executable instructions, such as RAM, ROM, EEPROM, flash memory, a hard disk drive, an optical disc, or the like. In some examples, the machine readable media 504 may be a tangible, non-transitory medium. The machine readable media 504 may be disposed within the systems 100 and 200 respectively, in which case the executable instructions may be deemed installed or embedded on the system. Alternatively, the machine readable media 504 may be a portable (e.g., external) storage medium.

As described further herein below, the machine readable media 504 may be encoded with a set of executable instructions. It should be understood that part or all of the executable instructions and/or electronic circuits included within one box may, in alternate forms, be included in a different box shown in the figures or in a different box not shown. Some implementations may include more or fewer instructions than are shown in FIG. 5.

In FIG. 5, instructions may be used to generate synthetic search queries. Instructions 506, when executed, cause the processing resource 502 to generate first prompt to query LLM(s) to extract focused item attributes for a specific item and receive them from the LLM(s). This LLM processing allows a large amount of attributes and item data to be reduced to focused item attributes relating to the specific item. Instructions 508, when executed, cause the processing resource 502 to generate a second prompt based on the focused item attributes and on item information to query LLM(s) to generate synthetic search queries, each synthetic search query including a combination of values. This LLM processing generates synthetic search queries based on the specific focused item attributes. In one form, it is contemplated that one or more trained models may be used to determine and input these prompts to LLM(s) to generate the synthetic search queries as the ultimate results or output.

Instructions 510, when executed, cause the processing resource 502 to tag each of the synthetic search queries with value pairs including a focused item attribute and a value. In one form, this tagging represents the ground truth of the machine learning trained model(s). Blocks 512 and 514 include possible alternative instructions. Instructions 512, when executed, cause the processing resource 502 to instruct a sequence tagging model to communicate with a search interface of an ecommerce platform to use the synthetic search queries as a reference when tagging a user search query with attributes. Alternatively, instructions 514, when executed, cause the processing resource 502 to use synthetic search queries and tagged value pairs to modify the sequence tagging model associated with the search interface of the ecommerce platform. In one form, the sequence tagging model may assign tags to user search queries. Instructions 516, when executed, cause the processing resource 502 to instruct a reinforcement learning model and receive feedback to modify at least one trained model. Feedback may be used to adjust the trained model(s).

Generally speaking, pursuant to various embodiments, systems, apparatuses, and methods are provided herein useful to generating synthetic search queries tagged to item attributes. In some embodiments, there is provided a system including: a database including an item catalog containing a plurality of items with a plurality of attributes and a plurality of values associated with the plurality of attributes; a processing resource; and a machine readable medium storing instructions. The instructions, when executed by the processing resource, cause the processing resource to: generate, using a first trained model, a first prompt to query at least one large language model (LLM) to extract a plurality of focused item attributes for a specific item; receive, from the at least one LLM, the plurality of focused item attributes for the specific item; generate, using a second trained model, a second prompt based on the plurality of focused item attributes and based on item information regarding the specific item to query the at least one LLM to generate a plurality of synthetic search queries, each synthetic search query including a combination of values for the specific item; tag, using the second trained model, each of the plurality of synthetic search queries with a plurality of value pairs, each value pair including a focused item attribute and a value for the focused item attribute for the specific item; and receive the plurality of tagged synthetic search queries from the at least one LLM.

In some implementations, the plurality of item attributes includes one or more of brand, color, item line, condition, size, and model. In some implementations, the item information regarding the specific item includes input from individuals selling the specific item, a description of the specific item, and/or a title of the specific item. In some implementations, the system further includes instructions that, when executed, cause a processing resource to instruct a reinforcement learning model and receive feedback to modify the first trained model and/or the second trained model. In some implementations, the system further includes instructions that, when executed, cause a processing resource to instruct a sequence tagging model to communicate with a search interface of an ecommerce platform to use the plurality of synthetic search queries as a reference when tagging a user search query with attributes. In some implementations, the synthetic search queries and corresponding tagged value pairs are used to modify a sequence tagging model associated with a search interface of an ecommerce platform, the sequence tagging model assigning tags to user search queries at the search interface. In some implementations, the at least one LLM comprises a plurality of LLMs that are implemented one after another in a series operation or that are implemented at the same time in a parallel operation. In some implementations, the processing resource and the machine readable medium are part of a cloud computing system and at least one of the first trained model, the second trained model, and the third training model are executed by the cloud computing system.

In another form, there is a method including: generating, using a first trained model, a first prompt to query at least one large language model (LLM) to extract a plurality of focused item attributes for a specific item; receiving, from the at least one LLM, the plurality of focused item attributes for the specific item; generating, using a second trained model, a second prompt based on the plurality of focused item attributes and based on item information regarding the specific item to query the at least one LLM to generate a plurality of synthetic search queries, each synthetic search query including a combination of values for the specific item; tagging, using the second trained model, each of the plurality of synthetic search queries with a plurality of value pairs, each value pair including a focused item attribute and a value for the focused item attribute for the specific item; and receiving the plurality of tagged synthetic search queries from the at least one LLM.

In some implementations, the method further includes instructing a reinforcement learning model and receiving feedback to modify the first trained model and/or the second trained model. In some implementations, the method further includes instructing a sequence tagging model to communicate with a search interface of an ecommerce platform to use the plurality of synthetic search queries as a reference when tagging a user search query with attributes. In some implementations, the method further includes using the synthetic search queries and corresponding tagged value pairs to modify a sequence tagging model associated with a search interface of an ecommerce platform, the sequence tagging model assigning tags to user search queries at the search interface. In some implementations, the at least LLM comprises a plurality of LLMs that are implemented one after another in a series operation or that are implemented at the same time in a parallel operation. In some implementations, the processing resource and the machine readable medium are part of a cloud computing system and at least one of the first trained model, the second trained model, and the third training model are executed by the cloud computing system.

In another form, there is provided a non-transitory machine readable medium storing instructions that, when executed, cause a processing resource to: generate, using a first trained model, a first prompt to query at least one large language model (LLM) to extract a plurality of focused item attributes for a specific item; receive, from the at least one LLM, the plurality of focused item attributes for the specific item; generate, using a second trained model, a second prompt based on the plurality of focused item attributes and based on item information regarding the specific item to query the at least one LLM to generate a plurality of synthetic search queries, each synthetic search query including a combination of values for the specific item; tag, using the second trained model, each of the plurality of synthetic search queries with a plurality of value pairs, each value pair including a focused item attribute and a value for the focused item attribute for the specific item; and receive the plurality of tagged synthetic search queries from the at least one LLM.

In some implementations, the instructions, when executed, cause the processing resource to instruct a reinforcement learning model and receive feedback to modify the first trained model and/or the second trained model. In some implementations, the instructions, when executed, cause the processing resource to instruct a sequence tagging model to communicate with a search interface of an ecommerce platform to use the plurality of synthetic search queries as a reference when tagging a user search query with attributes. In some implementations, the instructions, when executed, cause the processing resource to use the synthetic search queries and corresponding tagged value pairs to modify a sequence tagging model associated with a search interface of an ecommerce platform, the sequence tagging model assigning tags to user search queries at the search interface. In some implementations, the at least one LLM comprises a plurality of LLMs that are implemented one after another in a series operation or that are implemented at the same time in a parallel operation. In some implementations, the processing resource and the machine readable medium are part of a cloud computing system and at least one of the first trained model, the second trained model, and the third training model are executed by the cloud computing system.

In another form, there is provided a system including: a first trained model to be stored in a machine readable medium and to be executed by a processing resource, the first trained machine learning model to generate a first prompt to query at least one large language model (LLM) to extract a plurality of focused item attributes for a specific item; a second trained model to be stored in the machine readable medium and to be executed by the processing resource, the second trained machine learning model to generate a second prompt based on the plurality of focused item attributes and based on item information regarding the specific item to query the at least one LLM to generate a plurality of synthetic search queries, each synthetic search query including a combination of values for the specific item; and the second trained machine learning model to tag each of the plurality of synthetic search queries with a plurality of value pairs, each value pair including a focused item attribute and a value for the focused item attribute for the specific item . In some implementations the processing resource includes a plurality of processing resources and the machine readable medium includes a plurality of machine readable mediums.

Those skilled in the art will recognize that a wide variety of other modifications, alterations, and combinations can also be made with respect to the above described embodiments without departing from the scope of the disclosure, and that such modifications, alterations, and combinations are to be viewed as being within the ambit of the inventive concept.

1. A system comprising:
a database including a product catalog containing a plurality of products with a plurality of product attributes and a plurality of values associated with the plurality of product attributes;
a processing resource; and
a machine readable medium storing instructions that, when executed by the processing resource, cause the processing resource to:
instruct a first trained model to assess the plurality of product attributes to generate a first input prompt to query at least one large language model (LLM) to extract a plurality of focused product attributes for a specific product, each focused product attribute constituting a feature of the specific product;
receive, from the at least one LLM, the plurality of focused product attributes for the specific product;
instruct a second trained model to generate a second input prompt based on the plurality of focused product attributes and based on product information regarding the specific product to query the at least one LLM to generate a plurality of synthetic search queries, each synthetic search query including a combination of values for the specific product that might be inputted by a user;
instruct the second trained model to tag each of the plurality of synthetic search queries with a plurality of value pairs, each value pair including a focused product attribute and a value for the focused product attribute for the specific product; and
apply the tagged synthetic search queries as reference inputs to modify operation of a sequence tagging model associated with a search platform for products, modification of the operation including adjusting tag-assignment parameters or tagging behavior of the sequence tagging model so that future user search queries are tagged based, at least in part, on attribute-value pairs associated with the tagged synthetic search queries.

2. The system of claim 1, wherein the plurality of focused item product attributes comprises one or more of brand, color, item line, condition, size, and model.

3. The system of claim 1, wherein the product information regarding the specific product comprises input from individuals selling the specific product, a description of the specific product, and/or a title of the specific product.

4. The system of claim 1, further comprising instructions that, when executed, cause the processing resource to instruct a reinforcement learning model and receive feedback to modify the first trained model and/or the second trained model.

5-6. (canceled)

7. The system of claim 1, wherein the at least one LLM comprises a plurality of LLMs that are implemented one after another in a series operation or that are implemented at the same time in a parallel operation.

8. The system of claim 1, wherein the processing resource and the machine readable medium are part of a cloud computing system and at least one of the first trained model and the second trained model are executed by the cloud computing system.

9. A method comprising:
instructing a first trained model to assess a plurality of product attributes to generate a first input prompt to query at least one large language model (LLM) to extract a plurality of focused product attributes for a specific product, each focused product attribute constituting a feature of the specific product;
receiving, from the at least one LLM, the plurality of focused product attributes for the specific product;
instructing a second trained model to generate a second input prompt based on the plurality of focused product attributes and based on product information regarding the specific product to query the at least one LLM to generate a plurality of synthetic search queries, each synthetic search query including a combination of values for the specific product that might be inputted by a user;
instructing the second trained model to tag each of the plurality of synthetic search queries with a plurality of value pairs, each value pair including a focused product attribute and a value for the focused product attribute for the specific product; and
applying the tagged synthetic search queries as reference inputs to modify operation of a sequence tagging model associated with a search platform for products, modification of the operation including adjusting tag-assignment parameters or tagging behavior of the sequence tagging model so that future user search queries are tagged based, at least in part, on attribute-value pairs associated with the tagged synthetic search queries.

10. The method of claim 9, further comprising instructing a reinforcement learning model and receiving feedback to modify the first trained model and/or the second trained model.

11-12. (canceled)

13. The method of claim 9, wherein the at least LLM comprises a plurality of LLMs that are implemented one after another in a series operation or that are implemented at the same time in a parallel operation.

14. The method of claim 9, wherein at least one of the first trained model and the second trained model are executed by a cloud computing system.

15. A non-transitory machine readable medium storing instructions that, when executed, cause a processing resource to:
instruct a first trained model to assess a plurality of product attributes to generate a first input prompt to query at least one large language model (LLM) to extract a plurality of focused product attributes for a specific product, each focused product attribute constituting a feature of the specific product;
receive, from the at least one LLM, the plurality of focused product attributes for the specific product;
instruct a second trained model to generate a second input prompt based on the plurality of focused product attributes and based on product information regarding the specific product to query the at least one LLM to generate a plurality of synthetic search queries, each synthetic search query including a combination of values for the specific product that might be inputted by a user;
instruct the second trained model to tag each of the plurality of synthetic search queries with a plurality of value pairs, each value pair including a focused product attribute and a value for the focused product attribute for the specific product; and
apply the tagged synthetic search queries as reference inputs to modify operation of a sequence tagging model associated with a search platform for products, modification of the operation including adjusting tag-assignment parameters or tagging behavior of the sequence tagging model so that future user search queries are tagged based, at least in part, on attribute-value pairs associated with the tagged synthetic search queries.

16. The non-transitory machine readable medium of claim 15,
wherein the instructions, when executed, cause the processing resource to instruct a reinforcement learning model and receive feedback to modify the first trained model and/or the second trained model.

17-18. (canceled)

19. The non-transitory machine readable medium of claim 15,
wherein the at least one LLM comprises a plurality of LLMs that are implemented one after another in a series operation or that are implemented at the same time in a parallel operation.

20. The non-transitory machine readable medium of claim 15,
wherein the processing resource and the machine readable medium are part of a cloud computing system and at least one of the first trained model and the second trained model are executed by the cloud computing system.

21. The system of claim 1, further comprising instructions that, when executed, cause the processing resource to;
generate, via the sequence tagging model, an attribute-tagged representation of a future user search query based, at least in part, on attribute-value pairs associated with the tagged synthetic search queries; and
provide the attribute-tagged representation to the search platform to retrieve products in the product catalog corresponding to the attribute-value pairs.

22. The system of claim 1, wherein each value pair comprises:
a focused product attribute selected from brand, product line, model identifier, color, or size; and
a corresponding value that specifies that focused product attribute.

23. The system of claim 1, wherein:
generating the second input prompt comprises programmatically populating a prompt template with the plurality of focused product attributes and the product information by inserting attribute-value information into predefined template fields to form a structured machine-readable query.

24. The system of claim 1, wherein:
generating the first input prompt and the second input prompt comprises applying post-processing rules executed by the first and second trained models to select portions of LLM-generated output from an LLM processing stage and to assemble the selected portions into prompts having a predefined structure.
